(19) United States
(12) Patent Application Publication
(10) Pub. No.: US 2014/0110950 A1
(43) Pub. Date: Apr. 24, 2014

(54) Roadway Electricity Generating Apparatus

(71) Applicant: Charles G. Danna, SR., Tomball, TX (US)

(72) Inventor: Charles G. Danna, SR., Tomball, TX (US)

(21) Appl. No.: 13/656,036

(22) Filed: Oct. 19, 2012

(51) Int. Cl. H02K 7/18

(52) U.S. Cl. 290/1 R

(57) ABSTRACT

An electricity generation apparatus for use in generating electricity from an automobile operating on the roadway includes an input assembly first portion configured to rest on a roadway and a second portion coupled to the first portion and extending downwardly beneath the roadway. The first portion is configured to actuate the second portion when the automobile passes over the first portion. The input assembly second portion includes rack and pinion gears. The apparatus includes an output shaft having opposed first and second ends, the output shaft first end being operatively coupled to the input assembly second portion and configured to rotate when actuated by the input assembly second portion. A generator is operatively coupled to the output shaft second end and configured to generate electricity when the output shaft is actuated.

### BACKGROUND OF THE INVENTION

This invention relates generally to electricity generating devices and, more particularly, to an apparatus for use in generating electricity from an automobile operating on the roadway. The roadway electricity generating apparatus continuously operates a generator as automobiles run over an input assembly situated atop a roadway.

Electricity is most often generated by using another source of energy to operate a turbine. For example, a turbine may be operated by the energy of flowing water, wind, or from engines operated by the heat of burning fossil fuels. Most electricity generation is accomplished using electromagnetic induction, in which mechanical energy forces an electrical generator to rotate. Accordingly, a limitation of traditional turbine based electrical energy is that it is accomplished by converting another source of energy—resulting in the other form of energy being used up in the process or having to be obtained at great cost or effort.

Therefore, it would be desirable to have a turbine based electricity generating apparatus that causes an electrical generator to operate without consuming another valuable form of energy and without having to expend other resources to obtain the energy source for operating the generator. More particularly, it would be desirable to have an electricity generator that is repeatedly rotated as vehicles on a roadway merely drive over an input assembly to the generator.

### SUMMARY OF THE INVENTION

An electricity generation apparatus for use in generating electricity from an automobile operating on the roadway includes an input assembly first portion configured to rest on a roadway and a second portion coupled to the first portion and extending downwardly beneath the roadway. The first portion is configured to actuate the second portion when the automobile passes over the first portion. The input assembly second portion includes rack and pinion gears. The apparatus includes an output shaft having opposed first and second ends, the output shaft first end being operatively coupled to the input assembly second portion and configured to rotate when actuated by the input assembly second portion. A generator is operatively coupled to the output shaft second end and configured to generate electricity when the output shaft is actuated.

Therefore, a general object of this invention is to provide an electricity generation apparatus for use in generating electricity from an automobile operating on the roadway.

Another object of this invention is to provide an electricity generating apparatus, as aforesaid, that includes a rack and pinion gear train that actuates an electricity generator when an automobile presses down upon a platform spread across a roadway.

Still another object of this invention is to provide an electricity generating apparatus, as aforesaid, that generates electricity when an automobile presses down upon an input assembly and when the input assembly returns to its normal position after the automobile removes pressure from the input assembly.

Yet another object of this invention is to provide an electricity generating apparatus, as aforesaid, which may be housed in a space beneath a roadway.

A further object of this invention is to provide an electricity generating apparatus, as aforesaid, that operates a generator continuously so long as traffic continuously drives over the input assembly.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1a is a perspective view of a roadway electricity generating apparatus according to a preferred embodiment of the present invention;

FIG. 1b is an isolated view on an enlarged scale taken from a portion of FIG. 1a;

FIG. 2a is a side view of the apparatus as in FIG. 1a with the housing removed and illustrating an input assembly in a compressed or down configuration;

FIG. 2b is another front view as in FIG. 2a illustrating the input assembly in a released or up configuration;

FIG. 3a is a side view of the apparatus as in FIG. 2a;

FIG. 3b is a side view of the apparatus as in FIG. 2b;

FIG. 4a is another front view of the apparatus as in FIG. 2a;

FIG. 4b is a front view of the apparatus as in FIG. 4a with an auxiliary rack and pinion gear train removed;

FIG. 5a is a front view on an enlarged scale of the input assembly and gear train assembly illustrating with arrows the rotational direction of all gears when the input assembly second portion is moving toward a down configuration;

FIG. 5b is a front view on an enlarged scale of the input assembly and gear train assembly illustrating with arrows the rotational direction of all gears when the input assembly second portion is moving toward an up configuration;

FIG. 6a is a perspective view of the input assembly and gear train assembly as in FIG. 5a;

FIG. 6b is a perspective view of the input assembly and gear train assembly as in FIG. 5b; and

FIG. 7 is a perspective view of an arrangement of the present invention having an two electricity apparatuses side by side.

### DESCRIPTION OF THE PREFERRED EMBODIMENT

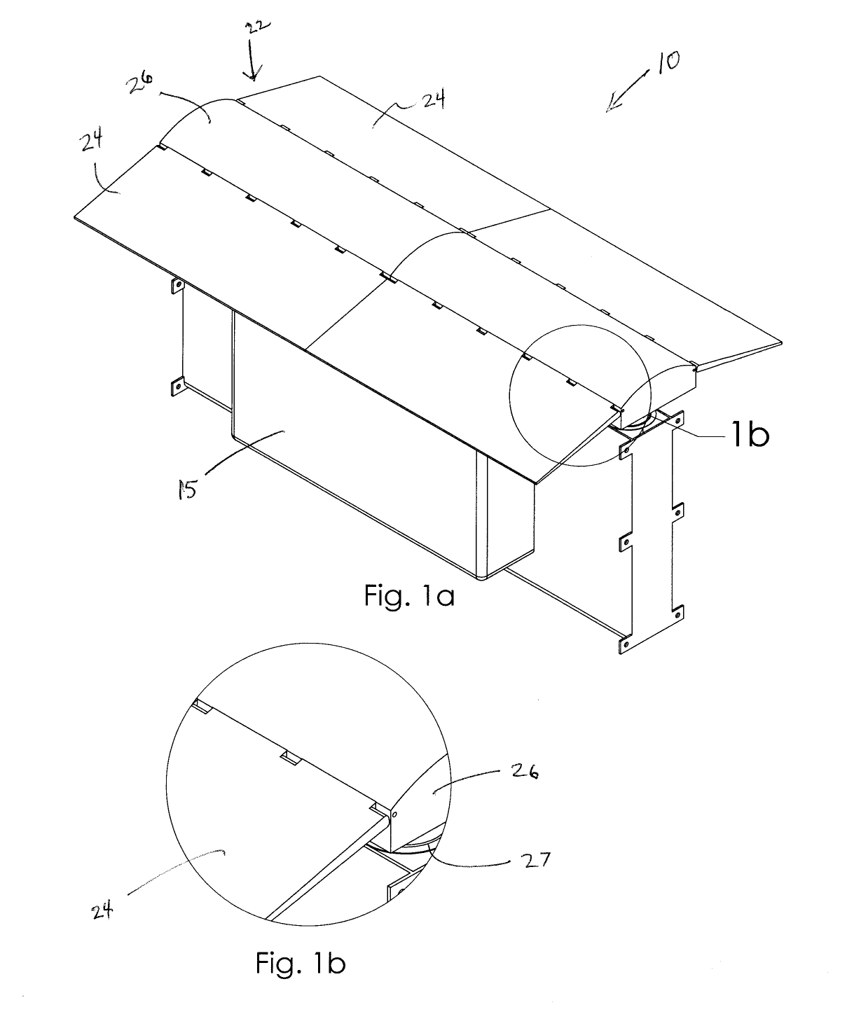

A roadway electricity generating apparatus according to a preferred embodiment of the present invention will now be described with reference to FIGS. 1a to 7 of the accompanying drawings. The electricity generating apparatus 10 includes an input assembly, an output shaft 14 operatively coupled to the input assembly, and an electricity generator 12 operatively coupled to the output shaft 14.

The input assembly is the means by which energy is introduced into the apparatus 10 that may be used to rotate the electricity producing generator 12. The input assembly includes a first portion 22 that may be mounted atop a roadway. Specifically, the input assembly first portion 22 may include a generally planar platform having a configuration that may be situated in a horizontal plane of a roadway. In other words, the platform may lie generally flat atop a roadway although it is preferably secured thereto such as with bolts (FIG. 1). As shown, the platform may include ramp portions 24 between which a main actuation member 26 may be sandwiched.

The input assembly further includes an input assembly second portion 28 that is coupled to the main actuation member 26 of the input assembly first portion 22 and extends downwardly beneath a road surface. As will be discussed further below, a housing 39 may be positioned in a chamber beneath the roadway that is configured to receive the components of the apparatus 10 other than the input assembly first portion 22. The input assembly first portion 22 is configured to receive the weight of a passing automobile and to transmit the energy thereof to the input assembly second portion 28.

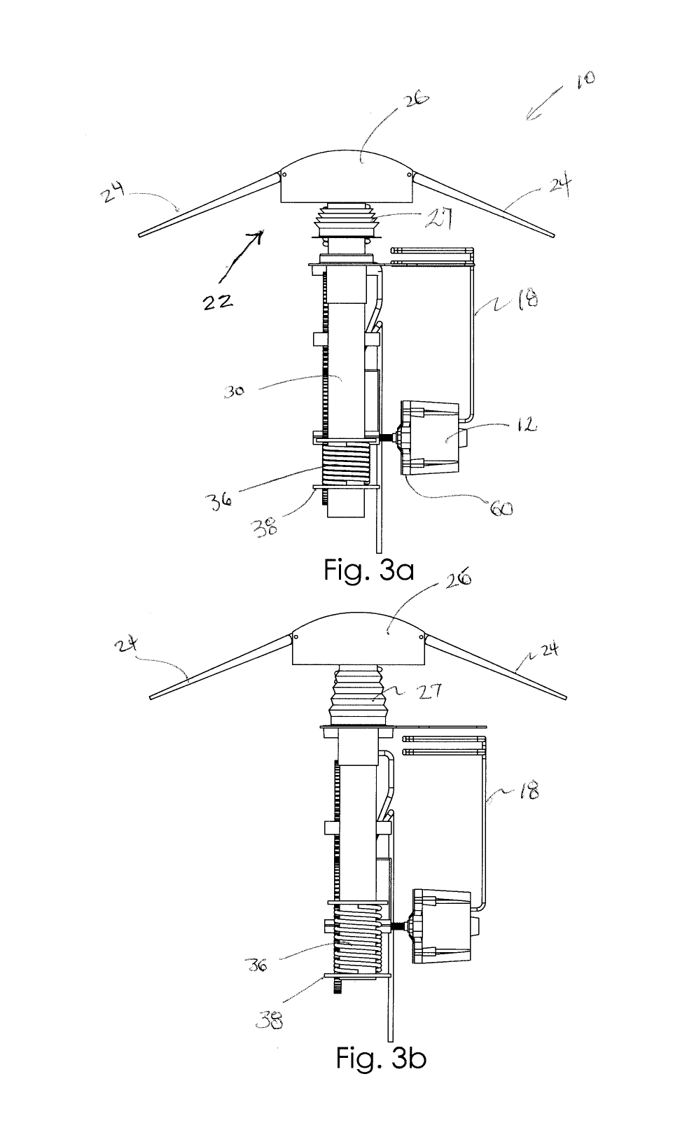

The input assembly second portion 28 may include at least one rod 30 extending generally vertically below the first portion 22 and being slidably movable between a “down configuration” (FIG. 3a) when an automobile is momentarily situated atop the first portion 22 and an “up configuration” (FIG. 3b) when the automobile is no longer situated atop the first portion 22. A compression spring 36 is mounted to a base plate 38 and is coupled to a lower end of the rod 30, such as with a collar 39. The spring 36 normally biases the rod 30 toward the up configuration when the weight of an automobile is not pushing the rod 30 toward the down configuration.

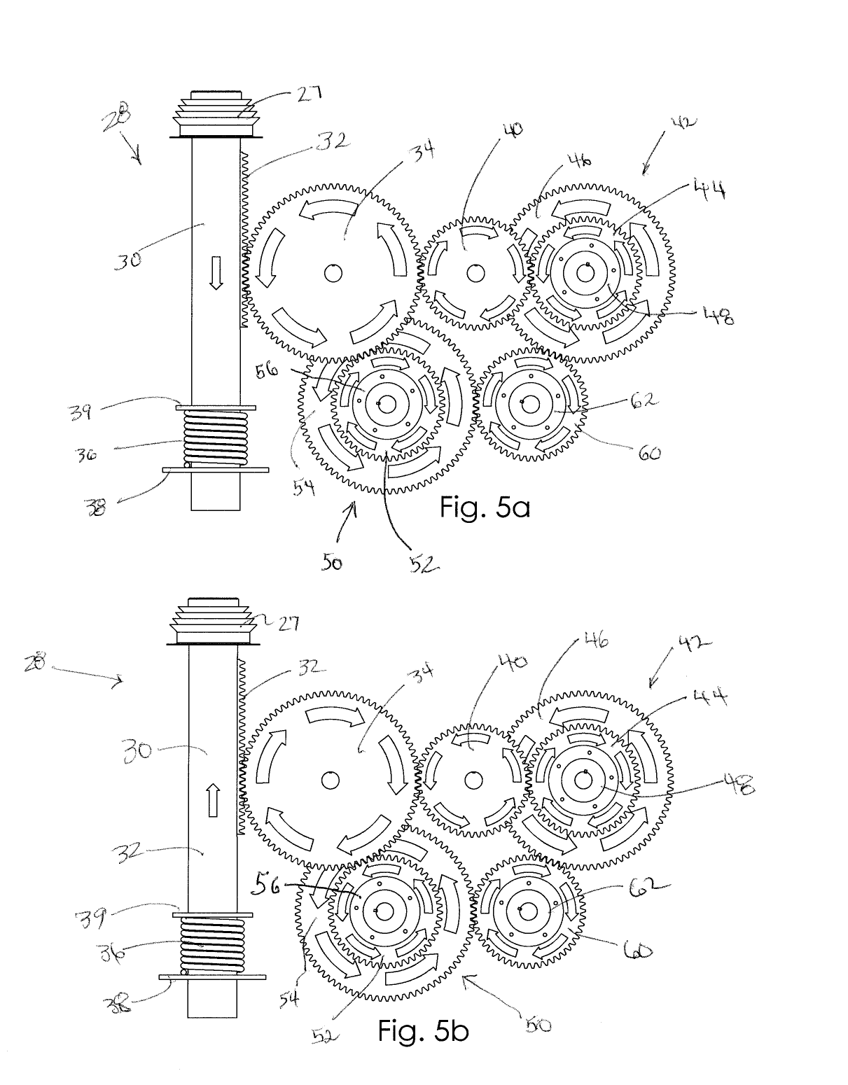

The input assembly second portion 28 may include a rack gear 32 mounted on an inner surface of the rack gear 32, the rack gear 32 having a linear configuration defining a plurality of rack gear teeth (FIGS. 5a and 5b). In fact, the rack gear 32 may be referred to as the component that is movable between up and down configurations as it moves with the rod 30.

The input assembly second portion 28 may also include a pinion gear 34 having teeth in operative connection to the teeth of the rack gear 32. The pinion gear 34 has the effect of translating linear movement of the rack gear 32 into rotational movement. The rack and pinion gears are configured such that the pinion gear 34 is moved in a counter-clockwise direction when the rack gear 32 is moved toward the down configuration (FIG. 5a) and is moved in a clockwise direction when the rack gear 32 is moved toward the up configuration (FIG. 5b).

The apparatus 10 includes a functional gear train interconnecting the input assembly second portion 28 (including the rack and pinion gears) to the output shaft 14. Although unexpected, the output shaft 14 is rotated in the same direction regardless of whether the rack gear 32 is moved toward the up configuration or the down configuration, as will be described in more detail below.

The gear train includes an idler gear 40 operatively coupled to the pinion gear 34 with complementary teeth and configured such that the idler gear 40 is rotated in an opposite rotational direction than the pinion gear 34 (FIG. 5a). Based on the configuration of the rack and pinion gears discussed above, the idler gear 40 is configured to rotate in a clockwise direction when the rack gear 32 is moved toward the down configuration (FIG. 5a) and is configured to rotate in a counter-clockwise direction when the rack gear 32 is moved toward the up configuration (FIG. 5b).

Further, the gear train includes a first drive gear combination 42 that includes a first drive gear first portion 42 and a first drive gear second portion 46. The first drive gear first portion 42 is coupled (with teeth) to the idler gear 40 and in a manner so as to rotate in a direction opposite the rotation of the idler gear 40 (FIG. 5a). The first drive gear second portion 46 is coupled to the first drive gear first portion 42 with a first drive gear freewheel ratchet 48 that is configured such that the first drive gear second portion 46 always rotates in only a single direction. As shown in FIGS. 5a and 5b, the first drive gear second portion 46 always rotates in a counter-clockwise rotation. In FIG. 5a, the first drive gear second portion 46 rotates in the same direction as the first drive gear first portion 42. However, in FIG. 5b, the first drive gear second portion 46 rotates opposite the rotation of the first drive gear first portion 42 and represents free-wheeling.

Still further, the gear train includes a second drive gear combination 50 that includes a second drive gear first portion 52 and a second drive gear second portion 54. The second drive gear first portion 52 is operatively coupled to the pinion gear 34 with complementary teeth and in a manner so as to rotate in a direction opposite rotation of the pinion gear 34 (FIG. 5a). The second drive gear second portion 54 is coupled to the second drive gear first portion 52 with a second drive gear freewheel ratchet 56 that is configured such that the second drive gear second portion 54 always rotates in only a single direction. As shown in FIGS. 5a and 5b, the second drive gear second portion 54 always rotates in a counter-clockwise rotation. In FIG. 5b, the second drive gear second portion 54 rotates in the same direction as the second drive gear first portion 52. However, in FIG. 5a, the second drive gear second portion 54 rotates opposites the rotation of the second drive gear first portion 52 and represents free-wheeling.

The gear train further includes an output gear 60 coupled to the first drive gear second portion 46 and also to the second drive gear second portion 54 with complementary teeth, respectively. Since the first drive gear second portion 46 and the second drive gear second portion 54 rotate in the same direction—counterclockwise in FIGS. 5a and 5b—the output gear 60 always rotates in an opposite direction—clockwise in the present drawings. The output gear 60 is coupled to the output shaft 14 which, in turn, is coupled to the generator 12. As the output shaft 14 rotates, the generator 12 is actuated to produce electricity.

The output shaft 14 may be coupled to the output gear 60 with a free wheel ratchet 62 such that the output shaft 14 cannot cause the output gear 60 to rotate in an opposite (counter clockwise) direction. This is important because when an automobile is no longer urging the input assembly second portion 28 to the down configuration, the rack gear 32 and rod 30 has returned to the up configuration by urging of the compression spring 36, and the entire gear train has ceased all movement, the generator 12 may continue to rotate for a brief time and then spin in reverse rotational movement briefly—causing the output shaft 14 to also reverse direction. This reverse action would normally cause the entire gear train to reverse direction and cause an unintended movement of the input assembly second portion 28. But because of the free wheel ratchet 62 coupling the output shaft 14 to the output gear 60, this unintended consequence is avoided.

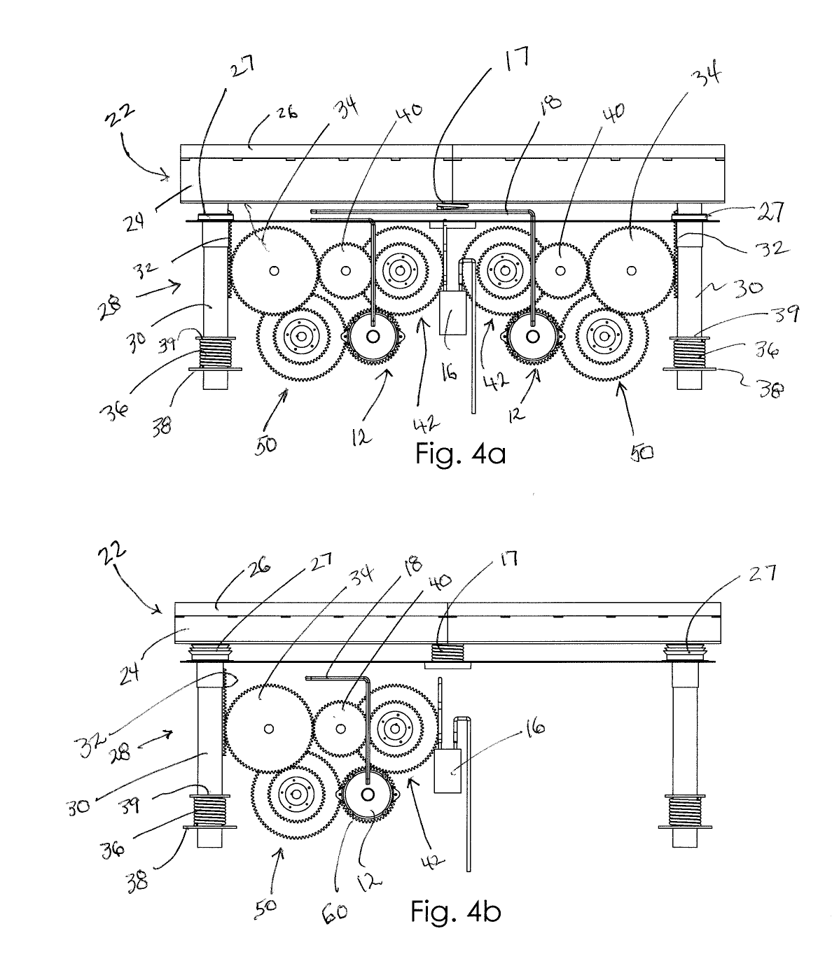

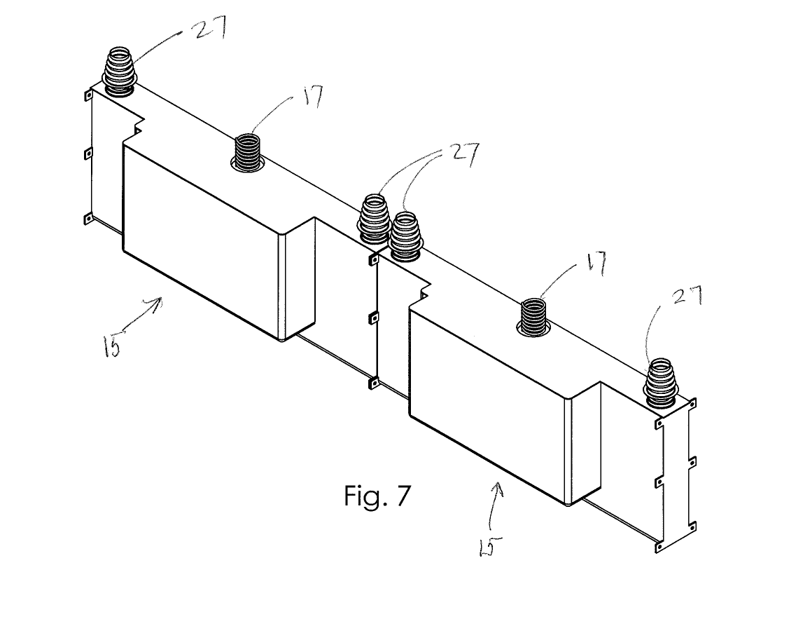

The apparatus 10 further includes a housing 39 situated beneath the roadway that is configured to contain the components other than the input assembly first portion 22 (FIG. 1a). Preferably, the housing 39 is constructed of a material that is waterproof so that the inner components, e.g. the gear train, are protected from moisture, rodents, and the like. The housing 39 may be accessed by authorized personnel, such as by removing input assembly first portion 22, i.e. the platform (FIG. 7). In addition, a sump pump 16 may be positioned in the housing 39 and configured to pump water out of the housing 39 in the unintended case that water does get into the housing 39 (FIG. 4a).

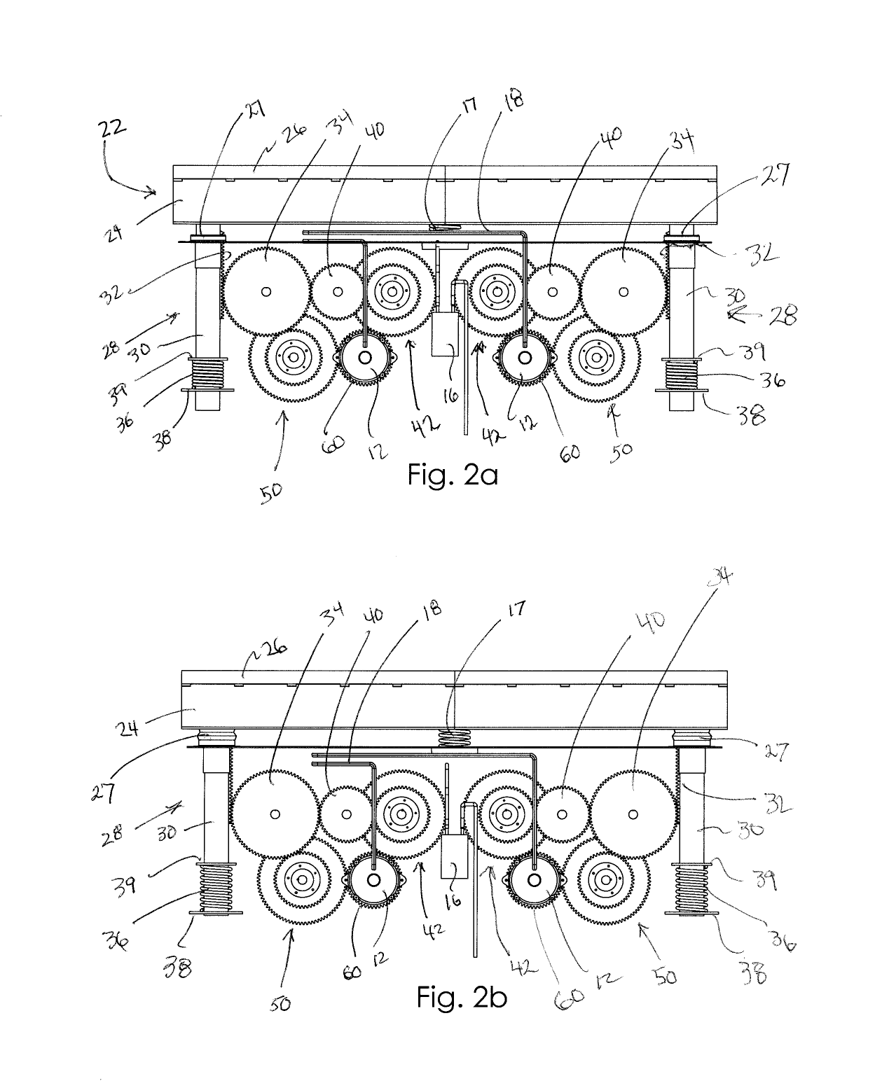

Various alternative combinations of the components discussed above may be used in practice. As shown in FIGS. 2a and 4a, two identical gear trains may be situated inside a single housing 39. More particularly, an auxiliary input assembly second portion 28 may be operatively coupled to and depend from the input assembly first portion 22. All other components related to the second gear train may be referred to as an “auxiliary” components. In the drawings, however, the same numerals are used to reference like auxiliary components. In another embodiment shown in FIG. 4b, only a single gear train is utilized. By contrast, two or more housings may be coupled together to increase the number of platform and gear trains available to convert the energy of passing vehicles into electricity (FIG. 7).

Each input assembly includes a resilient support boot 27 sandwiched between the actuation member 26 and a respective rod 30. Each boot 27 includes an accordion shaped configuration to partially absorb an impact force of a vehicle suddenly bearing its weight against the input assembly first portion 22 (i.e. the actuation member 26) and to distribute the impact energy. A single support spring 17 is positioned about midway between the support boots 27 and is configured to evenly distribute an impact force to the pair of input assembly second portions.

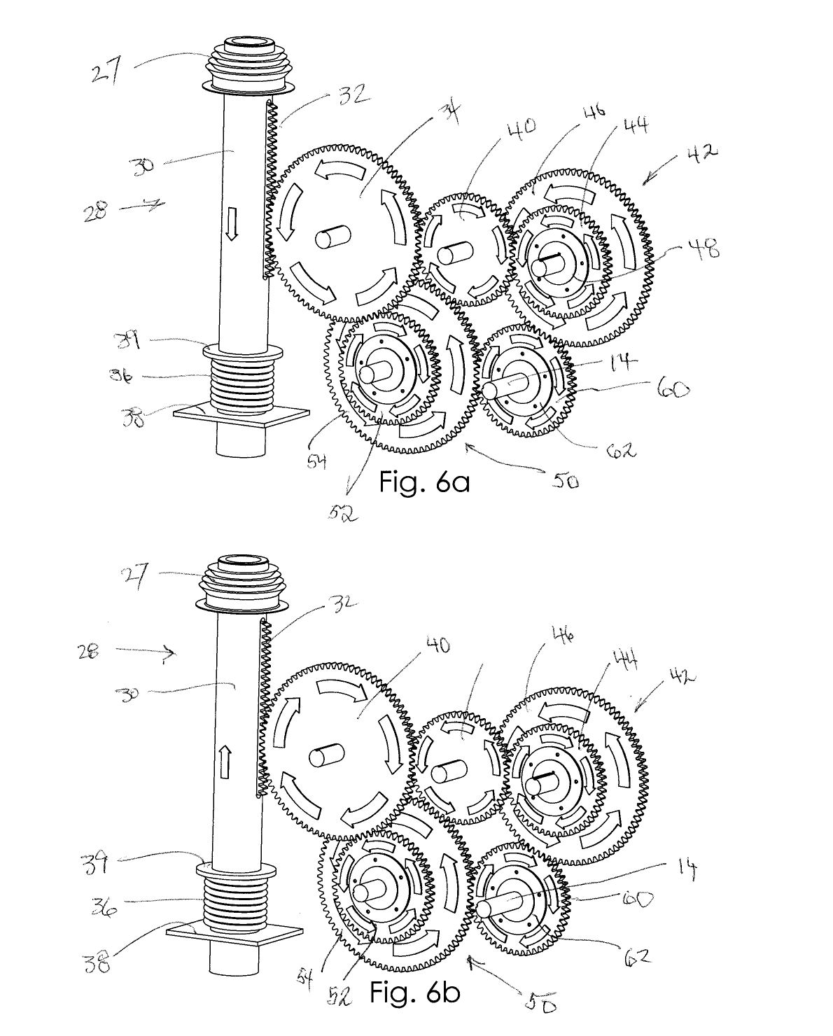

In operation, a housing 39 and the components of the present invention housed therein as described above may be positioned beneath a roadway. The input assembly first portion 22, including the actuation member 26 may be positioned within the plane of the roadway such that the actuation member 26 is in operative communication with the input assembly second portion 28 including the rack and pinion gear combination. When a vehicle passes over the apparatus 10, a downward impact force is exerted upon the input assembly which causes the rack gear 32 to move toward the down configuration. This movement is best illustrated in FIG. 6a. In this instance, the first drive gear first and second portions are rotated in a counterclockwise direction and the output gear 60 is actively rotated thereby. The second drive gear second portion 54 just freewheels in this instance—not providing any active rotational force to the output gear 60 but not resisting movement of the output gear 60 either even though the second drive gear first portion 52 is rotated in an opposite direction.

Once the vehicle passes away from the input assembly first portion 22, the compression spring 36 urges the rack gear 32 and rod 30 toward the up configuration. Operation of the gear train in this instance is best illustrated in FIG. 6b. Specifically, the second drive gear first and second portions are rotated in a counterclockwise direction and the output gear 60 is actively rotated thereby. The first drive gear second portion 46 just freewheels in this instance—not providing any active rotational force to the output gear 60 but not resisting movement of the output gear 60 either even though the first drive gear first portion 42 is being rotated in an oppose direction. As shown in FIG. 4a, electricity generated by a generator 12 may be transmitted to an electricity storage media or grid through wires 18.

The main conclusion to be drawn from the above description of operation is that the output shaft 14 is rotated so as to actuate the generate to generate electricity when the rack gear 32 and rod 30 are moved to a down configuration (FIG. 6a) and also when the rack gear 32 is pushed toward the up configuration by the compression spring 36 (FIG. 6b). In other words, electricity is generated by operation of the present apparatus when a vehicle runs over the input assembly first portion 22 and when the input assembly first portion 22 is released.

It is understood that while certain forms of this invention have been illustrated and described, it is not limited thereto except insofar as such limitations are included in the following claims and allowable functional equivalents thereof.

1. A roadway electricity generation apparatus for use in generating electricity from an automobile operating on the roadway, comprising:
an input assembly having an input assembly first portion situated in a common horizontal plane of the roadway and a second portion operatively coupled to said input assembly first portion and extending downwardly beneath the roadway, said input assembly first portion configured to actuate said input assembly second portion when the automobile passes over the input assembly first portion;
an output shaft having opposed first and second ends, said output shaft first end being operatively coupled to said input assembly second portion and configured to rotate when actuated by said input assembly second portion;
a generator operatively coupled to said output shaft second end and configured to generate electricity when said output shaft is actuated.

2. The electricity generation apparatus as in claim 1, wherein said input assembly second portion is configured to move to a down configuration when the automobile is situated atop said input assembly first portion and to an up configuration when the automobile is no longer situated atop said input assembly first portion.

3. The electricity generation apparatus as in claim 2, wherein:
said input assembly first portion includes a platform configured to lay atop the roadway;
said input assembly second portion includes:
a rack gear having a linear configuration operatively coupled to said platform and configured to be moved toward said down configuration when the automobile exerts downward pressure upon said platform;
a pinion gear having a circular configuration coupled to said rack gear;
wherein said pinion gear is turned in a counterclockwise direction when said rack gear is moved toward said down configuration; and
wherein said pinion gear is moved in a clockwise direction when said rack gear is moved toward said up configuration.

4. The electricity generation apparatus as in claim 3, wherein said wherein said output shaft is rotated in a same rotational direction when said rack gear is moved toward said down configuration and when said rack gear is moved toward said up direction.

5. The electricity generation apparatus as in claim 2, wherein said wherein said output shaft is rotated in a same rotational direction when said input assembly second portion is moved toward said down configuration and when said rack gear is moved toward said up direction.

6. The electricity generation apparatus as in claim 4, further comprising:
an idler gear operatively coupled to said pinion gear, said idler gear being configured to rotate in a direction opposite a rotational direction of said pinion gear; and
wherein said idler gear is configured to rotate in a clockwise direction when said rack gear is moved toward said down configuration and configured to rotate in a counterclockwise direction when said rack gear is moved toward said up configuration.

7. The electricity generation apparatus as in claim 6, further comprising a first drive gear combination, said first drive gear combination including:
a first drive gear first portion coupled to said idler gear and configured to rotate in a direction opposite a rotational direction of said idler gear; and
a first drive gear second portion coupled to said first drive gear first portion with a first free wheel ratchet such that said first drive gear second portion always rotates in only one direction.

8. The electricity generation apparatus as in claim 3, further comprising a second drive gear combination, said second drive gear combination including:
a second drive gear first portion coupled to said pinion gear and configured to rotate in a direction opposite a rotational direction of said pinion gear; and
a second drive gear second portion coupled to said second drive gear first portion with a second free wheel ratchet such that said second drive gear second portion always rotates in only one direction.

9. The electricity generation apparatus as in claim 7, further comprising a second drive gear combination, said second drive gear combination including:
a second drive gear first portion coupled to said pinion gear and configured to rotate in a direction opposite a rotational direction of said pinion gear; and
a second drive gear second portion coupled to said second drive gear first portion with a second free wheel ratchet such that said second drive gear second portion always rotates in only one direction.

10. The electricity generation apparatus as in claim 9, further comprising:
an output gear coupled to said first drive gear second portion and to said second drive gear second portion; and
wherein:
said output shaft first end is fixedly coupled to said output gear and configured to rotate in a same direction as a rotational direction of said output gear; and
said output shaft second is coupled to said generator such that said generator produces electricity when said output gear and said output shaft are rotated.

11. The electricity generation apparatus as in claim 2, wherein said input assembly second portion includes a compression spring situated beneath said rack gear, said spring being configured to normally bias said rack gear toward said up configuration.

12. The electricity generation apparatus as in claim 3, further comprising a housing coupled to and extending below said input assembly, said rack gear, said pinion gear, said output shaft, and said generator being positioned inside said housing.

13. The electricity generation apparatus as in claim 12, further comprising a sump pump situated in said housing, said sump pump configured to pump water out of said housing when activated.

14. The electricity generation apparatus as in claim 3, further comprising at least one boot sandwiched between said input assembly first portion and said rack gear, said boot having a resilient accordion-shaped configuration that softens and distributes an impact force received when the automobile is situated atop said input assembly first portion.

15. The electricity generation apparatus as in claim 1, further comprising:
an auxiliary input assembly second portion coupled to and extending beneath said input assembly first portion, said input assembly first portion configured to actuate said auxiliary input assembly second portion when the automobile passes over the input assembly first portion;
an auxiliary output shaft having opposed first and second ends, said auxiliary output shaft first end being operatively coupled to said auxiliary input assembly second portion and configured to rotate when actuated by said auxiliary input assembly second portion; and
an auxiliary generator operatively coupled to said auxiliary output shaft second end and configured to generate electricity when said auxiliary output shaft is actuated.

16. The electricity generation apparatus as in claim 10, wherein said output shaft is coupled to said output gear with a freewheel ratchet such that said output shaft is prevented from causing said output gear from rotating in an opposite direction.
